(19) United States
(12) Patent Application Publication
(10) Pub. No.: US 2024/0120515 A1
(43) Pub. Date: Apr. 11, 2024

(54) FUEL CELL SYSTEM

(71) Applicants: Hyundai Motor Company, Seoul (KR); Kia Corporation, Seoul (KR)

(72) Inventor: Mi Sun KIM, Yongin-Si (KR)

(73) Assignees: Hyundai Motor Company, Seoul (KR); Kia Corporation, Seoul (KR)

(21) Appl. No.: 18/218,857

(22) Filed: Jul. 6, 2023

(30) Foreign Application Priority Data
Oct. 6, 2022 (KR) 10-2022-0127896

(51) Int. Cl. H01M 8/04701; H01M 8/04089; H01M 8/04119; H01M 8/04228; H01M 8/04492; H01M 8/04537; H01M 8/04746

(52) U.S. Cl. CPC H01M 8/04716; H01M 8/04097; H01M 8/04126; H01M 8/04179; H01M 8/04228; H01M 8/04492; H01M 8/04604; H01M 8/04761

(57) ABSTRACT

A fuel cell system, includes a fuel cell stack, an air supply line connected to an inlet of an air electrode of the fuel cell stack to supply air, an integrated discharge line configured to be connected to an outlet of a hydrogen electrode of the fuel cell stack and discharge a waste product to outside, an integrated discharge valve provided in the integrated discharge line, a connection line configured to connect the integrated discharge valve and the air supply line, and a controller configured to control the integrated discharge valve to discharge the waste product to the outside through the integrated discharge line or to supply the waste product to the air supply line through the connection line.

### CROSS REFERENCE TO RELATED APPLICATION

The present application claims priority to Korean Patent Application No. 10-2022-0127896, filed Oct. 6, 2022, the entire contents of which is incorporated herein for all purposes by this reference.

### BACKGROUND OF THE PRESENT DISCLOSURE

### Field of the Present Disclosure

The present disclosure relates to a fuel cell system that prevents a backflow of waste products or freezing of the system caused by the waste products in low-temperature conditions by controlling the discharging direction of the waste products produced in a fuel cell stack.

### Description of Related Art

A fuel cell is a type of power generation device that directly converts chemical energy generated by oxidation of fuel into electrical energy. Fuel cells are a same as chemical cells in that they use oxidation-reduction reactions, but the fuel cells differ from the chemical cells in which a cell reaction is conducted inside a closed system in that reactants are continuously supplied from the outside thereof and reaction products are continuously removed out of the system.

A fuel cell system consists of a fuel cell stack that generates electrical energy through a chemical reaction, an air supply device that supplies air to an air electrode of the fuel cell stack, and a hydrogen supply device that supplies hydrogen to a hydrogen electrode of the fuel cell stack. When power is generated in the fuel cell stack, water is produced inside the fuel cell stack, and some of the water passes through an electrolyte membrane due to the concentration difference and is discharged to the hydrogen electrode. The discharged water is condensed and drained to the outside in the form of condensate. The hydrogen gas remaining after the reaction in the fuel cell stack is recycled and supplied to the hydrogen electrode or purged to the outside.

Conventionally, when purging hydrogen gas and draining water condensate, the gas or water was transferred to a humidifier to be discharged from the humidifier to the outside. However, when purging hydrogen gas by use of a humidifier, there is a problem that the hydrogen may flow back to the air electrode of the fuel cell stack. When the hydrogen flows back to the air electrode, a reverse voltage is generated in the fuel cell stack, which reduces the durability of the fuel cell stack. Furthermore, when water condensate is drained in low-temperature or cryogenic conditions, the water condensate discharged to the humidifier may solidify, causing the humidifier to freeze and block an air supply flow to the fuel cell stack. When the air supply flow path is blocked, it is impossible to supply air smoothly to the fuel cell stack, which, in turn, makes the power generation of the fuel cell stack impossible.

Moreover, as the water condensate discharged from the humidifier in the low-temperature or cryogenic conditions freezes an exhaust pipe, an air pressure control valve provided in the exhaust pipe may not be actuated and a discharge path of the discharged gas or water condensate may be blocked. When the discharge path of the discharged gas or water condensate is blocked, the fuel cell system cannot work normally.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell system that prevents a backflow of waste products or freezing of the system caused by the waste products in low-temperature conditions by controlling the discharging direction of the waste products produced in a fuel cell stack.

In various aspects of the present disclosure, according to an exemplary embodiment of the present disclosure, there is provided a fuel cell system, including: a fuel cell stack; an air supply line connected to an inlet of an air electrode (or referred as ‘cathode’) of the fuel cell stack to supply air thereto; an integrated discharge line connected to an outlet of a hydrogen electrode (or referred as ‘anode’) of the fuel cell stack and configured to discharge a waste product to outside thereof; an integrated discharge valve provided in the integrated discharge line; a connection line to connect the integrated discharge valve and the air supply line; and a controller configured to control the integrated discharge valve to discharge the waste product to the outside through the integrated discharge line or to supply the waste product to the air supply line through the connection line.

The integrated discharge valve may be configured as a three-way valve to move the waste product along the integrated discharge line or along the connection line.

The waste product from the fuel cell stack may be hydrogen gas remaining after a reaction at the hydrogen electrode of the fuel cell stack or water condensate produced in the fuel cell stack.

When discharging the waste product, the water condensate may be discharged first, and then the hydrogen gas may be discharged.

The controller may be configured to determine whether the fuel cell stack is configured for generating power when the water condensate or the hydrogen gas is discharged, and when the fuel cell stack is configured for generating power, determine a humidification state of the fuel cell stack to control the integrated discharge valve.

The controller may be configured to control the integrated discharge valve to discharge the hydrogen gas to the outside through the integrated discharge line when the hydrogen gas is discharged.

The controller may be configured to control the integrated discharge valve to discharge the water condensate to the outside through the integrated discharge line when the water condensate is discharged as power generation of the fuel cell stack is stopped.

The controller may be configured to control the integrated discharge valve to discharge the water condensate to the outside through the integrated discharge line when the water condensate is discharged as humidification of the fuel cell stack is not required.

The controller may be configured to control the integrated discharge valve to supply the water condensate to the air supply line through the connection line when the water condensate is discharged as humidification of the fuel cell stack is required.

The controller may be configured to control the integrated discharge valve to open the connection line when a discharge of the waste product is completed.

The fuel cell system may further include: a humidifier provided in the air supply line; a bypass valve provided at an upstream point of the humidifier based on an air flow in the air supply line; and a bypass line branching through the bypass valve to discharge air to the outside thereof, and wherein the controller may be configured to control the integrated discharge valve and the bypass valve simultaneously.

The humidifier may be connected to the connection line.

The bypass valve may be a valve with an adjustable opening to the air supply line and the bypass line.

The controller may be configured to control the bypass valve to open only the bypass line when power generation of the fuel cell stack is stopped.

The controller may be configured to determine whether to prevent freezing of water condensate when humidification of the fuel cell stack is not required, ensure that the air supply line and the bypass line are open when the controller concludes that preventing the water condensate from freezing is necessary, and control the bypass valve to open only the air supply line when it is unnecessary to prevent the water condensate from freezing.

The controller may allow only the air supply line to be opened when humidification of the fuel cell stack is required, and control the bypass valve to open the air supply line and the bypass line when hydrogen gas is discharged from the integrated discharge valve.

The controller may be configured to control the bypass valve to open only the air supply line when a discharge of the waste product is completed.

As described above, a fuel cell system of the present disclosure has an effect that freezing of the system caused by waste products in low-temperature conditions and a backflow of hydrogen gas into a fuel cell stack may be prevented by controlling the discharging direction of the waste products produced in the fuel cell stack.

Furthermore, the fuel cell system of the present disclosure has an effect that the amount of moisture inside a humidifier may be actively controlled by controlling the discharging direction of water condensate based on the humidification state of the fuel cell stack.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram of a fuel cell system according to an exemplary embodiment of the present disclosure;

FIG. 2 and FIG. 3 are flow charts of waste products for each state of a fuel cell stack in the fuel cell system according to the exemplary embodiment of the present disclosure;

FIG. 4, FIG. 5 and FIG. 6 are flow charts of air for each state of the fuel cell stack in the fuel cell system according to the exemplary embodiment of the present disclosure; and

FIG. 7 is a control flowchart of the fuel cell system according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION OF THE PRESENT DISCLOSURE

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

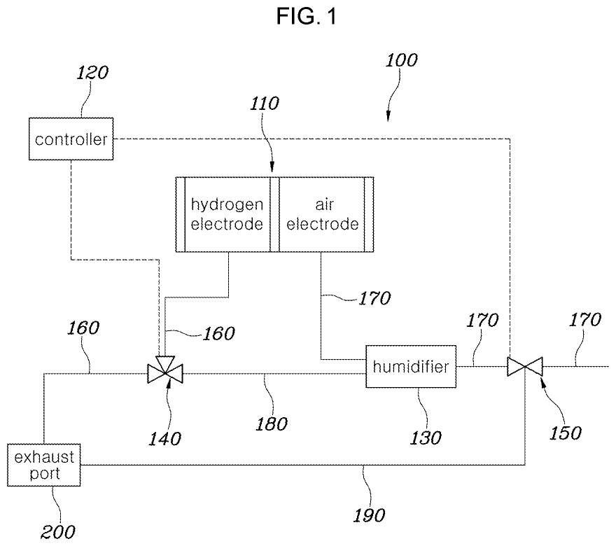

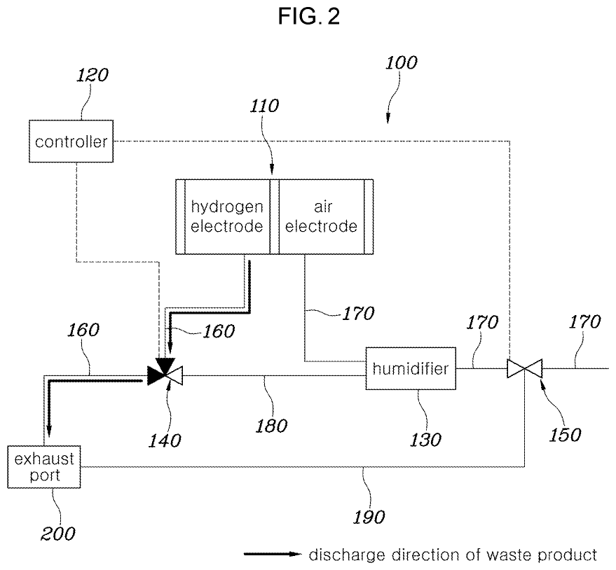

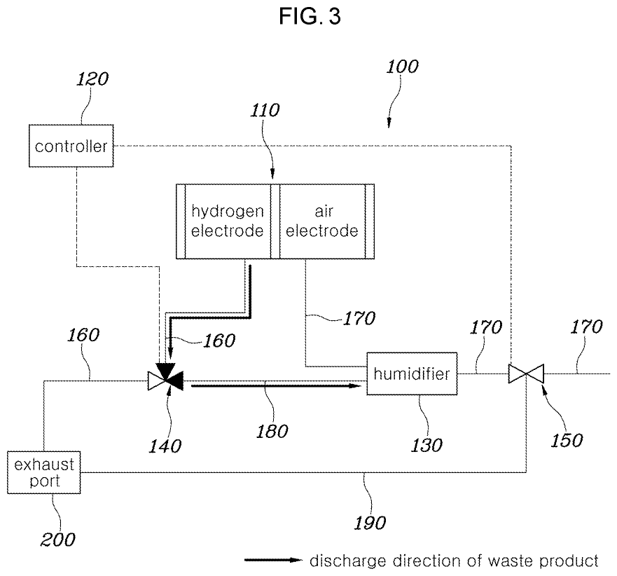

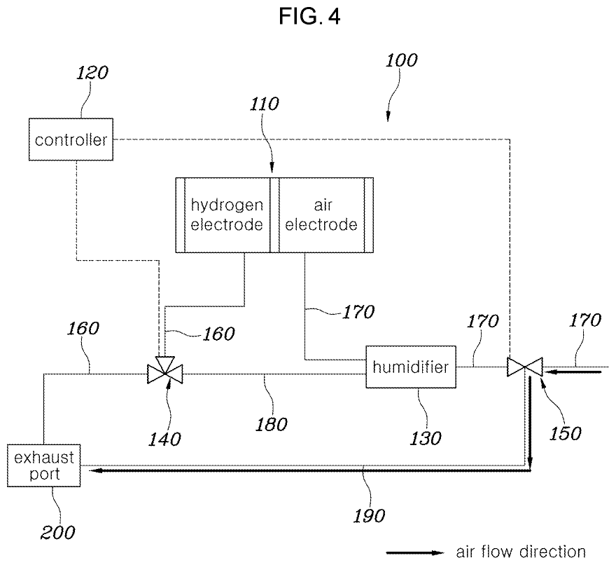

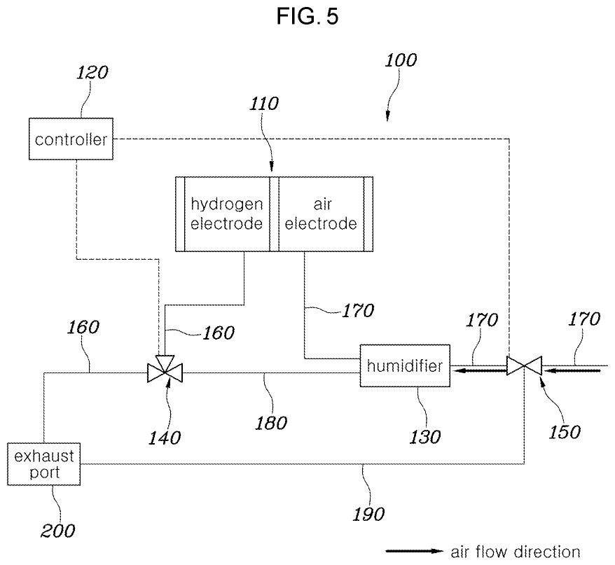

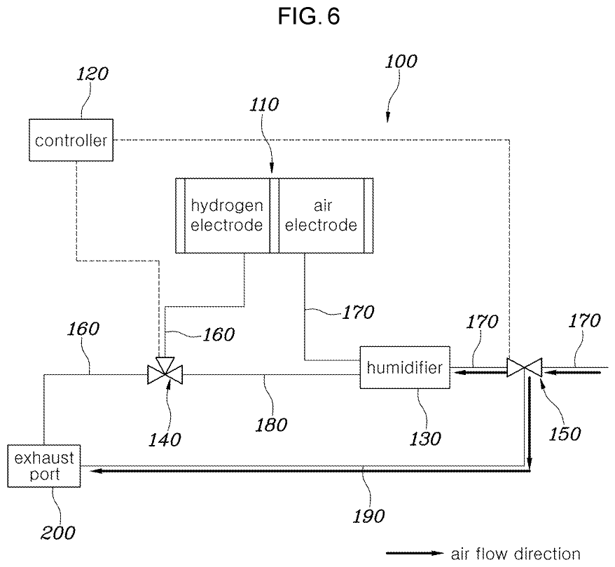

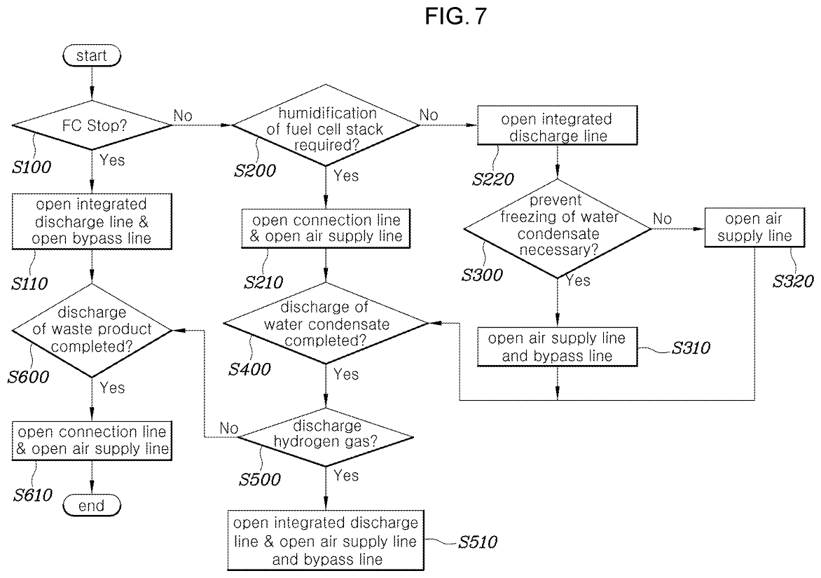

FIG. 1 is a schematic diagram of a fuel cell system according to an exemplary embodiment of the present disclosure; FIG. 2 and FIG. 3 are flow charts of waste products for each state of a fuel cell stack in the fuel cell system according to the exemplary embodiment of the present disclosure; FIG. 4, FIG. 5 and FIG. 6 are flow charts of air for each state of the fuel cell stack in the fuel cell system according to the exemplary embodiment of the present disclosure; and FIG. 7 is a control flowchart of the fuel cell system according to the exemplary embodiment of the present disclosure.

FIG. 1 is a schematic diagram of a fuel cell system according to an exemplary embodiment of the present disclosure. A fuel cell system 100 of the present disclosure includes: a fuel cell stack 110; an air supply line 170 connected to an inlet of an air electrode (or referred as ‘cathode’) of the fuel cell stack 110 to supply air thereto; an integrated discharge line 160 connected to an outlet of a hydrogen electrode (or referred as ‘anode’) of the fuel cell stack 110 to discharge a waste product to the outside; an integrated discharge valve 140 provided in the integrated discharge line 160; a connection line 180 connecting the integrated discharge valve 140 and the air supply line 170; and a controller 120 that is configured to control the integrated discharge valve 140 to discharge the waste product to the outside through the integrated discharge line 160 or to supply the waste product to the air supply line 170 through the connection line 180.

The controller 120 according to an exemplary embodiment of the present disclosure may be implemented as an algorithm configured to control the behavior of various components of a vehicle, or a non-volatile memory configured to store data pertaining to software instructions for reproducing the algorithm, and a processor configured to perform the operations described below using data stored in the memory. Here, the memory and the processor may be implemented as separate chips. Alternatively, the memory and the processor may be implemented as a single chip integrated with each other, and the processor may take the form of one or more processors.

The conventional fuel cell system is configured to supply a waste product generated from the hydrogen electrode of the fuel cell stack 110 to a humidifier 130 through the discharge valve. The waste product delivered to the humidifier 130 is discharged to the outside through a pipe that enables the discharge from the humidifier 130 to the outside. Yet, when the waste product is delivered to the humidifier 130, there is a problem in that a reverse voltage occurs in supplying air from the humidifier 130 to the fuel cell stack 110. Furthermore, there is also a problem in that the normal operation of the fuel cell system 100 is disturbed due to solidification of the waste product in low-temperature or cryogenic conditions. Accordingly, in an exemplary embodiment of the present disclosure, it is directed to control the discharging direction of the waste product generated from the hydrogen electrode of the fuel cell stack 110. In the fuel cell system 100 of the present disclosure, the integrated discharge valve 140 is configured as a three-way valve to move the waste product along the integrated discharge line 160 or along the connection line 180. The controller 120 may control the moving direction of the waste product by controlling the integrated discharge valve 140.

Meanwhile, waste products produced in the fuel cell stack 110 may be hydrogen gas remaining after a reaction at the hydrogen electrode of the fuel cell stack 110 or water condensate generated in the fuel cell stack 110. When hydrogen gas is supplied to the fuel cell stack 110, a chemical reaction is performed at the hydrogen electrode, and impurities including hydrogen gas remaining after the reaction are discharged through the outlet of the hydrogen electrode. Furthermore, at the air electrode of the fuel cell stack 110, water is generated after a chemical reaction between hydrogen and oxygen. Some of the water migrates to the hydrogen electrode due to the concentration difference, and the migrated water is condensed and discharged from the hydrogen electrode in a form of condensate.

At the present time, to solve the problem of the conventional fuel cell system, it is necessary to focus on the water condensate and residual hydrogen gas among the waste products discharged through the outlet of the hydrogen electrode. When the waste products are discharged, the water condensate is discharged first, and after the water condensate is discharged, the hydrogen gas is discharged. When the waste products produced in the fuel cell stack 110 move through the integrated discharge line 160, the water condensate and hydrogen gas included in the waste products move together. However, since the water condensate is in a liquid state and hydrogen gas is in a gaseous state, when the waste products are discharged from the outlet of the hydrogen electrode of the fuel cell stack 110, liquid water is discharged first, and then gaseous hydrogen is discharged after discharging the water condensate.

Thereafter, the controller 120 is configured to determine whether the fuel cell stack 110 generates power when water condensate or hydrogen gas is discharged, and when the fuel cell stack 110 is generating power, the controller is configured to determine the humidification state of the fuel cell stack 110 and is configured to control the integrated discharge valve 140. The controller 120 is configured to control the discharging direction of the water condensate or hydrogen gas according to the state of the fuel cell stack 110.

The controller 120 needs to control the discharging direction of waste products produced in the fuel cell stack 110 according to the state of the fuel cell stack 110. In the case of hydrogen gas, it is always necessary to be discharged to the outside through an exhaust port 200 to prevent a reverse flow to the fuel cell stack 110. Thus, the controller 120 is configured to control the integrated discharge valve 140 to discharge the hydrogen gas to the outside through the integrated discharge line 160 when the hydrogen gas is discharged. In the case of water condensate, the water condensate also needs to be discharged to the outside thereof, but it is necessary to control the discharging direction of the water condensate to supply the water condensate back into the fuel cell system 100 to be utilized according to the state of the fuel cell stack 110.

FIG. 2 and FIG. 3 are flow charts of waste products for each state of a fuel cell stack in the fuel cell system according to the exemplary embodiment of the present disclosure. FIG. 2 is a flow chart of the waste product when power generation of the fuel cell stack 110 is stopped, of the waste product when humidification of the fuel cell stack 110 is not required, or of the hydrogen gas when humidification of the fuel cell stack 110 is required. FIG. 3 is a flow chart of the water condensate when humidification of the fuel cell stack 110 is required or of the waste product when the system returns to the initial setting state.

First, the controller 120 is configured to control the integrated discharge valve 140 to discharge the water condensate to the outside through the integrated discharge line 160 when the water condensate is discharged as the power generation of the fuel cell stack 110 is stopped. That the power generation of the fuel cell stack 110 is stopped has the same meaning as that the fuel cell system 100 enters a stop state. When the fuel cell system 100 enters a stop state, it is necessary to discharge the waste product to the outside through the exhaust port 200 so that the waste product does not exist inside the fuel cell system 100. Therefore, as shown in FIG. 2, the controller 120 needs to control the integrated discharge valve 140 to discharge the waste product to the outside through the integrated discharge line 160 when the waste product is discharged as the power generation of the fuel cell stack 110 is stopped.

Meanwhile, the controller 120 is configured to determine the humidification state of the fuel cell stack 110 when the fuel cell stack 110 is generating power. The controller 120 is configured to determine the humidification state of the fuel cell stack 110, and when it is determined that humidification of the fuel cell stack 110 is not required, controls the integrated discharge valve 140 to discharge the water condensate to the outside through the integrated discharge line 160 when it is discharged. The controller 120 needs to determine the humidification state of the fuel cell stack 110 to control the discharging direction of the water condensate.

When the outside temperature is low or when the amount of power generation of the fuel cell stack 110 is small, which means the fuel cell stack 110 is in a low output state, or when the relative humidity of the air supplied to the fuel cell stack 110 is high, the controller 120 is configured to determine that humidification of the fuel cell stack 110 is not necessary. When humidification of the fuel cell stack 110 is not required, there is a problem that a “flooding” occurs in the fuel cell stack 110 when water condensate is supplied into the fuel cell system 100. Due to the provided configuration, normal power generation of the fuel cell stack 110 is impossible. However, in an exemplary embodiment of the present disclosure, the flooding phenomenon of the fuel cell stack 110 may be prevented by discharging the water condensate to the outside through the exhaust port 200 when humidification of the fuel cell stack 110 is not required as shown in FIG. 2.

On the other hand, when humidification of the fuel cell stack 110 is required, the controller 120 is configured to control the integrated discharge valve 140 to supply the water condensate to the air supply line 170 through the connection line 180 when the water condensate is discharged. When the outside temperature is high or when the amount of power generation of the fuel cell stack 110 is large, which means the fuel cell stack 110 is in a high output state, or when the relative humidity of the air supplied to the fuel cell stack 110 is low, the controller 120 is configured to determine that humidification of the fuel cell stack 110 is necessary.

When humidification of the fuel cell stack 110 is required but humidification is not performed, a “dry-out” occurs in the fuel cell stack 110. When the dry-out phenomenon occurs, normal power generation of the fuel cell stack 110 is impossible. However, in an exemplary embodiment of the present disclosure, the dry-out phenomenon of the fuel cell stack 110 may be prevented by supplying condensed water into the fuel cell system 100 when humidification of the fuel cell stack 110 is required as shown in FIG. 3.

When the discharge of the water condensate produced in the fuel cell stack 110 is finished, the controller 120 starts discharging hydrogen gas. When discharging the hydrogen gas after discharging the water condensate, the controller 120 is configured to control the integrated discharge valve 140 to discharge the hydrogen gas through the integrated discharge line 160 as shown in FIG. 2. The controller 120 is configured to determine the state of the fuel cell stack 110 and is configured to control the integrated discharge valve 140 accordingly. When the water condensate and hydrogen gas contained in the waste product are supplied back into the fuel cell system 100, a reverse voltage is generated in the fuel cell stack 110 by the hydrogen gas, which is problematic.

Therefore, the controller 120 needs to prevent the hydrogen gas from being supplied back to the fuel cell system 100 once the water condensate has been discharged by discharging the water condensate first and then discharging the hydrogen gas when discharging the waste product produced in the fuel cell stack 110. When the hydrogen gas is discharged, the controller is configured to control the integrated discharge valve 140 to discharge the hydrogen gas to the integrated discharge line 160, preventing the creation of a reverse voltage in the fuel cell stack 110.

Thereafter, when the discharge of the waste product from the fuel cell system 100 to the outside through the exhaust port 200 is completed, the controller 120 needs to control the integrated discharge valve 140 to return to the initial setting state. Accordingly, the controller 120 is configured to control the integrated discharge valve 140 to connect the connection line 180 when the discharge of the waste product is completed. The initial setting state of the integrated discharge valve 140 may vary depending on the configuration characteristics of the fuel cell stack 110 and the fuel cell system 100.

The initial setting state in an exemplary embodiment of the present disclosure is an example of the configuration characteristics of the fuel cell stack 110 and the fuel cell system 100, and corresponds to a case in which humidification control is essential. Thus, it is necessary to supply the water condensate generated in the fuel cell stack 110 back to the fuel cell system 100 for humidification control, and accordingly, the controller 120 needs to control the integrated discharge valve 140 as shown in FIG. 3.

Meanwhile, the fuel cell system 100 of the present disclosure may further include: a humidifier 130 provided in the air supply line 170; a bypass valve 150 provided at the upstream point of the humidifier 130 based on the air flow in the air supply line 170; and a bypass line 190 branching through the bypass valve 150 to discharge air to the outside thereof, and the controller 120 is configured to control the integrated discharge valve 140 and the bypass valve 150 at the same time.

The air introduced into the fuel cell system 100 needs to go through the humidifier 130 before being supplied to the fuel cell stack 110. Accordingly, the humidifier 130 needs to be provided in the air supply line 170. Furthermore, the connection line 180 is connected to the humidifier 130. The connection line 180 may be formed in various ways depending on a location connected to the air supply line 170.

The connection line 180 may be connected to an upstream point or a downstream point based on the air flow in the air supply line 170, or may be directly connected to the humidifier 130 provided in the air supply line 170. In the fuel cell system 100 of the present disclosure, the connection line 180 is connected to the humidifier 130. Due to the provided configuration, the waste product discharged from the fuel cell stack 110 may be provided to the humidifier 130, and the amount of water inside the humidifier 130 may be secured by utilizing the water condensate included in the waste product. Furthermore, by controlling the integrated discharge valve 140 according to the state of the fuel cell stack 110 to control the water condensate delivered to the humidifier 130, the amount of water inside the humidifier 130 may be adjusted.

Furthermore, in the fuel cell system 100, it is necessary to control the concentration of hydrogen gas in the exhaust port 200 to be below a certain reference value to minimize the risk of explosion or ignition due to the discharged hydrogen gas. In an exemplary embodiment of the present disclosure, there may be a problem in that the concentration of hydrogen gas in the exhaust port 200 is high because the hydrogen gas is directly discharged to the outside. Thus, it is necessary to further configure the bypass valve 150 and the bypass line 190 to discharge the air introduced into the fuel cell system 100 to the outside to reduce the concentration of the discharged hydrogen gas.

However, due to the configuration of the bypass line 190, it is difficult to secure the air flow required for the fuel cell stack 110 to generate electricity. Accordingly, the bypass valve 150 needs to be formed of a valve with an adjustable opening to the air supply line 170 and the bypass line 190, and the controller 120 needs to control the bypass valve 150 to ensure an appropriate air flow rate. Furthermore, as the controller 120 controls the bypass valve 150 and the integrated discharge valve 140 at the same time, it is possible to control the concentration of hydrogen gas at the exhaust port 200 when discharging hydrogen gas, and to secure the air flow rate required for power generation of the fuel cell stack 110. Hereinafter, the control of the bypass valve 150 by the controller 120 means controlling the bypass valve 150 simultaneously with the integrated discharge valve 140 under the same conditions as the conditions for controlling the integrated discharge valve 140.

FIG. 4, FIG. 5 and FIG. 6 are flow charts of air for each state of the fuel cell stack in the fuel cell system according to the exemplary embodiment of the present disclosure. FIG. 4 is a flow chart of air when power generation of the fuel cell stack 110 is stopped. FIG. 5 is a flow chart of air when humidification of the fuel cell stack 110 is required, when it is not necessary to prevent freezing of water condensate, or when the system returns to an initial setting state. FIG. 6 is a flow chart of air when hydrogen gas is discharged when humidification of the fuel cell stack 110 is required or when it is necessary to prevent freezing of water condensate.

The controller 120 is configured to control the bypass valve 150 to open only the bypass line 190 when the power generation of the fuel cell stack 110 is stopped. That the power generation of the fuel cell stack 110 is stopped has the same meaning as that the fuel cell system 100 enters a stop state, similarly to the case when the integrated discharge valve 140 is controlled. When the power generation of the fuel cell stack 110 is stopped, it is necessary to block the air supplied to the fuel cell stack 110 to prevent unnecessary power generation. Thus, as shown in FIG. 4, the controller 120 is configured to control the bypass valve 150 to block the air supply to the humidifier 130, and to open the bypass line 190 to lower the concentration of hydrogen gas discharged to the exhaust port 200 to allow air to flow through the exhaust port 200.

On the other hand, when the fuel cell stack 110 is generating power, it is necessary to determine the humidification state of the fuel cell stack 110 and control the air flow accordingly. When humidification of the fuel cell stack 110 is required, the controller 120 is configured to control the bypass valve 150 to open only the air supply line 170 when humidification of the fuel cell stack 110 is required, and the air supply line 170 and the bypass line 190 are opened when the hydrogen gas is discharged from the integrated discharge valve 140. The humidifier 130 is configured to remove impurities in the air before supplying the air introduced into the fuel cell system 100 to the fuel cell stack 110, and is also configured to increase the humidity of the air supplied to the fuel cell stack 110.

When humidification of the fuel cell stack 110 is required, the controller 120 is configured to control the integrated discharge valve 140 to supply water condensate to the humidifier 130. At the same time, as shown in FIG. 5, it is necessary that the controller 120 control the bypass valve 150 to open only the air supply line 170 to increase the humidification efficiency, and thus air introduced from the outside thereof may be supplied to the fuel cell stack 110 through the humidifier 130.

Thereafter, when the discharge of hydrogen gas from the integrated discharge valve 140 is started, the controller 120 is configured to control the bypass valve 150 to flow air through the air supply line 170 and the bypass line 190. When the discharge of hydrogen gas from the integrated discharge valve 140 starts, it is necessary to lower the hydrogen gas concentration at the exhaust port 200, and to open the bypass line 190 to lower the hydrogen gas concentration of the exhaust port 200. Furthermore, since the fuel cell stack 110 is still in a state of power generation, air needs to be continuously supplied to the fuel cell stack 110. Accordingly, the controller 120 is configured to control the bypass valve 150 to allow air to flow through the air supply line 170 and the bypass line 190 as shown in FIG. 6.

However, when controlling the bypass valve 150, the opening amount of the bypass valve 150 is adjusted to ensure an appropriate air flow rate according to the hydrogen gas discharge concentration. The main thing in the operation of the fuel cell system 100 is the power generation of the fuel cell stack 110. In an exemplary embodiment of the present disclosure, even when air flows through the exhaust port 200 to lower the concentration of hydrogen gas discharged to the exhaust port 200, it is necessary to secure enough air for the fuel cell stack 110 to generate electricity without any problem. When the hydrogen gas emission concentration increases, the amount of air required to lower the hydrogen gas concentration also increases.

Assuming a certain amount of air is introduced into the fuel cell system 100, when most of the introduced air flows to the exhaust port 200 to lower the concentration of the discharged hydrogen gas, a problem occurs in the power generation of the fuel cell stack 110. To solve the present problem, when the concentration of hydrogen gas emission increases, the amount of air introduced therein needs to be increased. The inflow of air may be easily increased by use of an air compressor. When the revolutions per minute (rpm) of the air compressor is increased, the amount of air introduced into the fuel cell system 100 increases, so that it is possible to lower the concentration of discharged hydrogen gas and secure air necessary for power generation of the fuel cell stack 110.

Meanwhile, the controller 120 is configured to determine whether to prevent freezing of the water condensate when humidification of the fuel cell stack 110 is not required. When it is determined that it is necessary to prevent the water condensate from freezing, the controller is configured to allow the air supply line 170 and the bypass line 190 to be opened, whereas when it is determined that it is not necessary to prevent the water condensate from freezing, the controller is configured to control the bypass valve 150 to open only the air supply line 170. When humidification of the fuel cell stack 110 is not required, the controller 120 is configured to determine whether the water condensate discharged from the integrated discharge valve 140 is prevented from freezing. When the water condensate is discharged from the integrated discharge valve 140, there is a problem that the water condensate freezes when exposed to low-temperature conditions in winter. To solve the problem of freezing of the water condensate, the flow of the introduced air is regulated. In a state in which humidification of the fuel cell stack 110 is not required, it is necessary to continuously supply air to the humidifier 130 because the fuel cell stack 110 may continue to generate power.

However, in the winter, the water condensate discharged to the exhaust port 200 may solidify. Solidification of the water condensate may be prevented by flowing air through the exhaust port 200 to the extent that the water condensate does not solidify. Accordingly, the controller 120 is configured to control the bypass valve 150 as shown in FIG. 6 to allow air to flow into the air supply line 170 and the bypass line 190. At the instant time, it is also necessary to appropriately control the amount of air flowing into the bypass line 190 by adjusting the opening amount of the bypass valve 150.

As the outside temperature decreases, the amount of air required to prevent solidification of water condensate in the exhaust port 200 increases. This may be solved by increasing the inflow of air when the outside temperature is lowered. The inflow of air may be easily increased by use of an air compressor. When the revolutions per minute (rpm) of the air compressor is increased, the amount of air introduced into the fuel cell system 100 increases, so that it is possible to secure the amount of air to prevent freezing of the water condensate and secure air necessary for power generation of the fuel cell stack 110.

When it is unnecessary to prevent the water condensate from freezing, the controller 120 is configured to control the bypass valve 150 to open the air supply line 170 as shown in FIG. 5 to supply air to the fuel cell stack 110. Accordingly, when the discharge of hydrogen gas starts after discharging the water condensate from the integrated discharge valve 140, the controller 120 is configured to control the bypass valve 150 to allow air to flow to the air supply line 170 and the bypass line 190 as shown in FIG. 6.

After the discharge of waste products is completed, the controller 120 is configured to control the bypass valve 150 to open only the air supply line 170.

The controller 120 needs to confirm that the discharge of the exhaust from the integrated discharge valve 140 is completed, and to return the bypass valve 150 to the initial setting state accordingly. Like the integrated discharge valve 140, the initial setting state may vary depending on the configuration characteristics of the fuel cell stack 110 and the fuel cell system 100. The initial setting state in an exemplary embodiment of the present disclosure is an example of the configuration characteristics of the fuel cell stack 110 and the fuel cell system 100, and corresponds to a case in which humidification control is essential. Therefore, the controller 120 needs to control the bypass valve 150 as shown in FIG. 5 so that air is supplied to the fuel cell stack 110 to continue the power generation of the fuel cell stack 110.

Meanwhile, FIG. 7 is a control flowchart of a fuel cell system according to the exemplary embodiment of the present disclosure, showing a flowchart in which the controller 120 controls the integrated discharge valve 140 and the bypass valve 150 provided in the fuel cell system 100.

First, the controller 120 is configured to determine whether the fuel cell stack 110 is in a state of power generation (S100). By determining whether the supply of air to the fuel cell stack 110 is cut off (FC Stop), it is possible to determine whether the fuel cell stack 110 is generating power. When the power generation of the fuel cell stack 110 is stopped, the controller 120 is configured to control the integrated discharge valve 140 to discharge the waste product to the integrated discharge line 160, and is configured to control the bypass valve 150 to flow air to the bypass line 190 (S110).

When the fuel cell stack 110 is generating power, the controller 120 is configured to determine whether humidification of the fuel cell stack 110 is necessary (S200). When humidification of the fuel cell stack 110 is required, the controller 120 is configured to control the integrated discharge valve 140 to discharge the waste product to the connection line 180, and is configured to control the bypass valve 150 to flow air to the air supply line 170 (S210). On the other hand, when humidification of the fuel cell stack 110 is not required, the controller 120 is configured to control the integrated discharge valve 140 to discharge the waste product to the integrated discharge line 160 (S220). The controller 120 is configured to control the bypass valve 150 at the same time. However, when controlling the bypass valve 150, the controller 120 is configured to determine whether it is necessary to prevent freezing of the water condensate (S300).

When it is necessary to prevent the water condensate from freezing, the controller 120 is configured to control the bypass valve 150 to allow air to flow to the air supply line 170 and the bypass line 190 (S310). On the other hand, when it is not necessary to prevent the water condensate from freezing, the controller 120 is configured to control the bypass valve 150 to flow air to the air supply line 170 (S320). Accordingly, the controller 120 is configured to determine the waste product discharged from the fuel cell stack 110 and when the discharge of the water condensate is completed (S400), the controller 120 is configured to determine whether to discharge the hydrogen gas (S500). When the hydrogen gas is discharged, the controller 120 is configured to control the integrated discharge valve 140 to discharge the hydrogen gas to the integrated discharge line 160, and is configured to control the bypass valve 150 to flow air to the air supply line 170 and the bypass line 190 (S510).

Thereafter, the controller 120 is configured to determine whether all of the waste products produced from the fuel cell stack 110 have been discharged to the outside thereof, that is, whether the discharge of the waste products is completed (S600). When the discharge of the waste products is completed, the controller 120 is configured to control the integrated discharge valve 140 to supply waste products to the connection line 180, and is configured to control the bypass valve 150 to supply air to the air supply line 170 (S610). The control process is terminated as the controller 120 controls the integrated discharge valve 140 and the bypass valve 150 to the initial setting state.

According to the fuel cell system of the present disclosure, by controlling the discharging direction of the waste product, it is possible to prevent the fuel cell system from freezing due to water condensate and to prevent a backflow of hydrogen gas into the fuel cell stack.

Furthermore, by controlling the discharging direction of the water condensate based on the humidification state of the fuel cell stack, the amount of moisture inside the humidifier may be actively controlled.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell system, comprising:
a fuel cell stack;
an air supply line connected to an inlet of an air electrode of the fuel cell stack to supply air thereto;
an integrated discharge line connected to an outlet of a hydrogen electrode of the fuel cell stack and configured to discharge a waste product to outside thereof;
an integrated discharge valve provided in the integrated discharge line;
a connection line to connect the integrated discharge valve and the air supply line; and
a controller configured to control the integrated discharge valve to discharge the waste product to the outside through the integrated discharge line or to supply the waste product to the air supply line through the connection line.

2. The fuel cell system of claim 1, wherein the integrated discharge valve is a three-way valve to move the waste product along the integrated discharge line or along the connection line.

3. The fuel cell system of claim 1, wherein the waste product from the fuel cell stack is hydrogen gas remaining after a reaction at the hydrogen electrode of the fuel cell stack or water condensate produced in the fuel cell stack.

4. The fuel cell system of claim 3, wherein when discharging the waste product, the water condensate is discharged first, and then the hydrogen gas is discharged.

5. The fuel cell system of claim 3, wherein the controller is configured to determine whether the fuel cell stack is generating power when the water condensate or the hydrogen gas is discharged, and when the controller concludes that the fuel cell stack is generating power, configured to determine a humidification state of the fuel cell stack to control the integrated discharge valve.

6. The fuel cell system of claim 3, wherein the controller is configured to control the integrated discharge valve to discharge the hydrogen gas to the outside through the integrated discharge line when the hydrogen gas is discharged.

7. The fuel cell system of claim 5, wherein the controller is configured to control the integrated discharge valve to discharge the water condensate to the outside through the integrated discharge line when the water condensate is discharged as power generation of the fuel cell stack is stopped.

8. The fuel cell system of claim 5, wherein the controller is configured to control the integrated discharge valve to discharge the water condensate to the outside through the integrated discharge line when the water condensate is discharged as humidification of the fuel cell stack is not required.

9. The fuel cell system of claim 5, wherein the controller is configured to control the integrated discharge valve to supply the water condensate to the air supply line through the connection line when the water condensate is discharged as humidification of the fuel cell stack is required.

10. The fuel cell system of claim 3, wherein the controller is configured to control the integrated discharge valve to open the connection line when a discharge of the waste product is completed.

11. The fuel cell system of claim 1, further including:
a humidifier provided in the air supply line;
a bypass valve provided at an upstream point of the humidifier based on an air flow in the air supply line; and
a bypass line branching through the bypass valve to discharge air to the outside thereof,
wherein the controller is configured to control the integrated discharge valve and the bypass valve simultaneously.

12. The fuel cell system of claim 11, wherein the humidifier is connected to the connection line.

13. The fuel cell system of claim 11, wherein the bypass valve is a valve with an adjustable opening to the air supply line and the bypass line.

14. The fuel cell system of claim 11, wherein the controller is configured to control the bypass valve to open only the bypass line when power generation of the fuel cell stack is stopped.

15. The fuel cell system of claim 11, wherein the controller is configured to determine whether to prevent freezing of water condensate when humidification of the fuel cell stack is not required, to ensure that the air supply line and the bypass line are open when the controller concludes that the preventing the water condensate from freezing is necessary, and to control the bypass valve to open only the air supply line when the controller concludes that the preventing the water condensate from freezing is unnecessary.

16. The fuel cell system of claim 11, wherein the controller is configured to allow only the air supply line to be opened when humidification of the fuel cell stack is required, and to control the bypass valve to open the air supply line and the bypass line when hydrogen gas is discharged from the integrated discharge valve.

17. The fuel cell system of claim 11, wherein the controller is configured to control the bypass valve to open only the air supply line when a discharge of the waste product is completed.

18. A method of controlling a fuel cell system including a fuel cell stack, an integrated discharge line connected to an outlet of a hydrogen electrode of the fuel cell stack, an integrated discharge valve provided in the integrated discharge line, a connection line to connect the integrated discharge valve and an air supply line, the method comprising:
determining, by a controller, whether the fuel cell stack is generating power when a waste product including at least one of water condensate and hydrogen gas is discharged, and when the controller concludes that the fuel cell stack is generating power, determining a humidification state of the fuel cell stack to control the integrated discharge valve;
controlling the integrated discharge valve to discharge the hydrogen gas to the outside through the integrated discharge line when the hydrogen gas is discharged; and
controlling the integrated discharge valve to open the connection line when a discharge of the waste product is completed.

19. A method of controlling a fuel cell system including a fuel cell stack, an air supply line connected to an inlet of an air electrode of the fuel cell stack to supply air, an integrated discharge line connected to an outlet of a hydrogen electrode of the fuel cell stack, an integrated discharge valve provided in the integrated discharge line, a connection line to connect the integrated discharge valve and an air supply line; a humidifier provided in the air supply line; a bypass valve provided at an upstream point of the humidifier; and
a bypass line branching through the bypass valve to discharge air to the outside thereof, the method comprising:
controlling, by a controller, the bypass valve to open only the bypass line when power generation of the fuel cell stack is stopped;
controlling the bypass valve to open only the air supply line when the controller concludes that preventing a water condensate of a waste product from freezing is unnecessary, and allowing only the air supply line to be opened when humidification of the fuel cell stack is required; and
controlling the bypass valve to open only the air supply line when a discharge of the waste product is completed.
